(19) United States
(12) Patent Application Publication
(10) Pub. No.: US 2006/0032200 A1
(43) Pub. Date: Feb. 16, 2006

(54) Screen for gases

(76) Inventor: Claes Karlebratt, Saffle (SE)

Correspondence Address: OSTROLENK FABER GERB & SOFFEN, 1180 AVENUE OF THE AMERICAS, NEW YORK, NY, 100368403, US

(21) Appl. No.: 10/525,310

(22) PCT Filed: Aug. 21, 2003
(86) PCT No.: PCT/SE03/01301

§ 371 Date: Jul. 20, 2005

(30) Foreign Application Priority Data
Aug. 22, 2002 (SE) 0202526-0

(51) Int. Cl. B01D 46/00

(52) U.S. Cl. 55/490

(57) ABSTRACT

The invention refers to a screen for gases intended to prevent passage of particles bigger than different, defined dimensions at the same time as the pressure drop existing over the screen is as low as possible. The screen is built up of rings connected together to a cylindrical package, which are individually separated by spacers in order to create slits between the rings which have dimensions adapted to the actual particles.

The present invention refers to a screen for gases intended to prevent passage of particles bigger than different defined dimensions near the valve seats in a valve at the same time as the pressure drop existing over said screen is as low as possible.

The different types of screens today existing on the market in order to prevent that particles bigger than different defined, customer-specified dimensions can pass the screen and cause problems with the tightening, show usually different types of hollow formations in cylinder covers or grating formations. One problem with this type of screen devices is that difficulties arise to dimension those slits in a simple way so that they prevent the passage of actual particles at the same time as the pressure drop over the screens is influenced negatively.

The object of the present invention is to eliminate the problems stated above and provide a screen, which has slits which very easy can be dimensioned to the dimensions specified by customers at the same time as the pressure drop over the screen can be kept as low as possible. The characterizing features of the invention are set forth in the following claims.

Thanks to the invention a screen of the type mentioned above has now been provided, which in an excellent way fulfils its purposes at the same time as it is also simple and cheap to manufacture. Since the screen is built up of to a cylindric package connected rings, which are separated individually by spacers, slots or rings can be created in a very easy way, which have dimensions adapted to the actual particles. Furtheron, the rings can be connected to each other into a package in a simple way in that the spacers are formed such as lips or shoulders on the rings in creating said slits and by aid of fixing joints on the periphery of the shoulders, the rings are orientated in position relatively each other. In order to keep the pressure drop over the screen as low as possible the dimension of the slits between the rings are formed so that said dimension increases in the actual flow direction of the medium, which creates a “Laval-nozzle” (recovery cone) for pressure recover.

The invention is described closer below by aid of a preferred embodiment example in view of the drawings enclosed, in which

FIG. 1 shows a side view in section of a screen according to the invention intended for location in a valve housing,

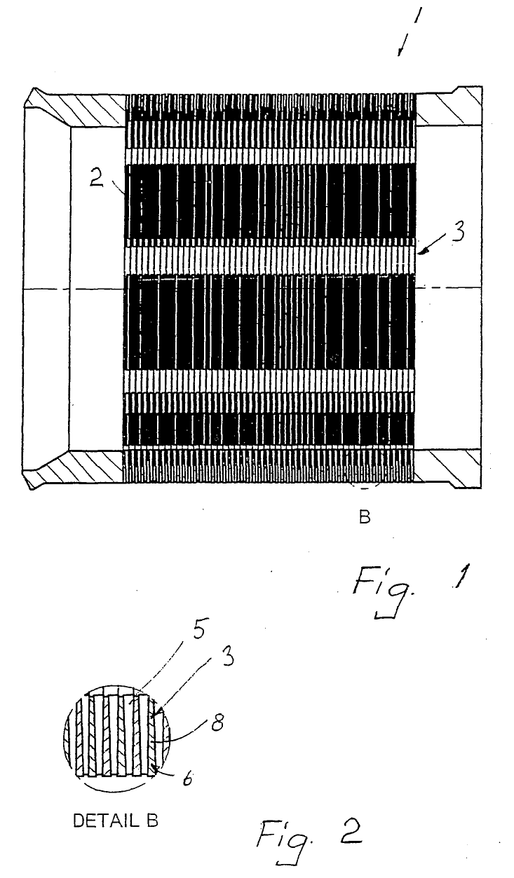

FIG. 2 shows in a view enlarged a partial view in section of the rings and the slits between these,

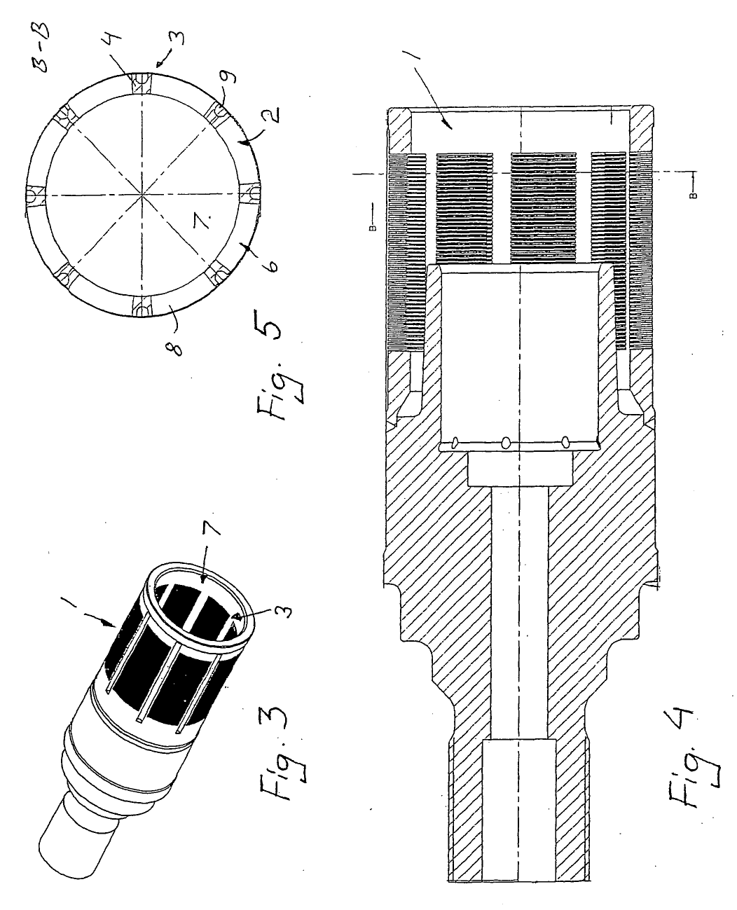

FIG. 3 shows a perspective view of screen arrangement according to the invention intended to be mounted into a valve,

FIG. 4 shows the view illustrated in FIG. 3 in a cross-section, from which can be seen how the screen arrangement is fixed in position before a montage into a valve,

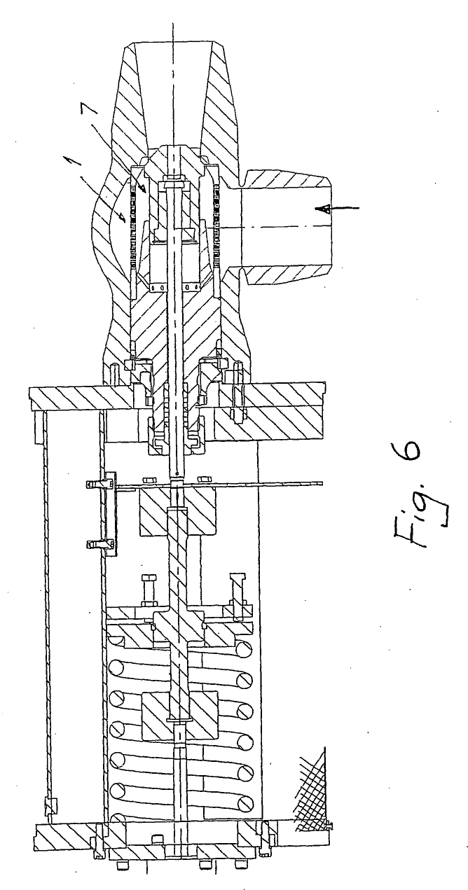

FIG. 5 shows a schematic cross-section of the screen according to FIG. 4 along a plane B-B and

FIG. 6 shows how a screen arrangement according to the invention can be mounted into a valve.

As can be seen closer in the drawings and especially in FIGS. 1, 2 and 5 a preferred embodiment example is here illustrated of a screen 1 according to the invention, which is built up of rings 2 connected into a cylindrical package, said rings are separated individually by spacers 3 in the form of lips or shoulders 4 in creating of slits 5 between the rings, which have dimensions adapted to the particles which are intended to be separated by aid of the screen 1. By this structure of the screen the same comprises slits 5 having different defined dimensions, which are created between the shoulders and which per se give an effective screen function. What can be seen from the figures the spacers 3 in the form of the shoulders 4 can be provided in a predetermined number and pattern between the rings on and around the circumference of the rings 2.

From FIGS. 2 and 5 can better be seen that the rings 2 comprise sheet formed washers 6 having a centrally located hollow formation 7, which is limited by a continuous strip 8 extending in the plane of extension of the washers 6, which has a predetermined width and a thickness which continuously decreases in the direction towards the hollow formations 7, so that the dimension of the slits increases in a direction inwards to the hollow formations 7 or in the actual flow direction of the medium in order to receive a pressure recover in the gas flow.

As mentioned above the shoulders 4 of the screen 1 are intended to create the actual slit 5 which is wanted and a weld-joint 9 is provided to keep the rings 2 together into a package by that the weld-joint 9 extends over the outer periphery of the shoulders 4. The dimension of the rings 2 i.e. the outer and inner diameter is determined by the equipment, which the screen is intended to work together with and in FIG. 6 is illustrated in a cross-section how the screen according to the invention can be mounted in a valve. The number of rings 2, which shall be placed in the final screen, are determined by the maximum pressure drop which is permitted for actual installation and the maximum pressure drop over the screen often is customer-specified.

1. A screen for gases intended to prevent passage of particles bigger than different defined dimensions at the same time as the pressure drop existing over the screen is as low as possible, said screen (1) is built up of to a cylindrical package connected rings (2), which are individually separated by spacers (3) for creating slits (5) between the rings (2), which have dimensions adapted to the actual particles, characterized in that the rings (2) consist of sheet-formed washers (6) having a centrally located hollow formation (7) limited by a continuous strip (8) extending into the plane of extension of the washers (6), said strip has a predetermined width and a thickness which continuously decreases in direction towards the hollow formation (7), the width of the slits being increased in the flow direction of the actual medium in order to receive a pressure recover in the gas flow and that the spacers (3) consist of shoulders (4) on the rings (2) in creating said slits (5), said shoulders (4) are provided in a predetermined pattern and number between the rings (2) and around the circumference of the rings (2) at the same time as the rings (2) are kept together into a package by aid of the shoulders (4).

2. A screen according to claim 1, characterized in that the rings (2) are kept together into a package by aid of weld-joints (9) extending over the outer periphery of the shoulders (4).
